(19) United States
(12) Patent Application Publication
(10) Pub. No.: US 2026/0036925 A1
(43) Pub. Date: Feb. 5, 2026

(54) IMAGE FORMING APPARATUS

(71) Applicant: FUJIFILM Business Innovation Corp., Tokyo (JP)

(72) Inventor: Kota TOMIOKA, Kanagawa (JP)

(73) Assignee: FUJIFILM Business Innovation Corp., Tokyo (JP)

(21) Appl. No.: 19/045,532

(22) Filed: Feb. 4, 2025

(30) Foreign Application Priority Data
Jul. 30, 2024 (JP) 2024-123463

(51) Int. Cl. G03G 15/16

(52) U.S. Cl. CPC G03G 15/1615; G03G 15/1625; G03G 2215/00409

(57) ABSTRACT

An image forming apparatus includes a transfer unit that comes into contact with an object to transfer an image to the object, a facing unit that moves together with the object in a transport direction of the object to bring the object into contact with the transfer unit, and a mechanism that brings the facing unit closer to the transfer unit in accordance with movement of the facing unit in the transport to bring the object into contact with the transfer unit and then further brings the facing unit and the transfer unit closer to each other.

### CROSS-REFERENCE TO RELATED APPLICATIONS

This application is based on and claims priority under 35 USC 119 from Japanese Patent Application No. 2024-123463 filed Jul. 30, 2024.

### BACKGROUND

### (i) Technical Field

The present invention relates to an image forming apparatus.

### (ii) Related Art

JP2013-72908A discloses an image forming apparatus including an image carrier that carries an image on a surface, a transfer member that is in pressure contact with the image carrier to form a transfer nip and that transfers the image on the image carrier to paper, a movable mechanism that sets a pressure contact state between the image carrier and the transfer member by moving the transfer member, and a control unit that controls the movable mechanism to variably control a nip load in the transfer nip, in which the control unit controls the nip load to a second load that is larger than a first load that is a nip load set in a case where a leading end of paper enters the transfer nip, based on a transport position of the paper after the leading end of the paper has passed through the transfer nip.

JP2022-500284A discloses a printing apparatus that is an apparatus for printing an image on an object having a generally cylindrical shape, the printing apparatus including: (i) a printing pressure station including a movable image forming surface on which an ink image is carried; and (ii) a transfer mechanism that moves the object forward through the printing pressure station, in which the transfer mechanism includes a driving member to which a plurality of mandrels that support one of the objects are connected in a rotatable manner, the transfer mechanism is configured such that the ink image on the image forming surface is transferred to a surface of the object by rotating each object while passing through the printing pressure station and causing rolling contact between the surface of the object and the image forming surface in a nip region of the printing pressure station, and the printing device is provided with (iii) a printing pressure platen on a side of the object opposite to the image forming surface in the nip region of the printing pressure station, the printing pressure platen being configured to apply a force to the object directly or through the mandrel such that rolling contact between the object and the image forming surface is ensured, the printing pressure platen being fixed in a moving direction of the image forming surface.

### SUMMARY

There is an image forming apparatus that transfers a toner image formed on a transfer body to an object. In a case of this transfer, a facing unit that moves in a transport direction in which the object is transported may be pressed against the transfer body with the object between the facing unit and the transfer body. In this case, in a case where the facing unit moves to a pressurization position at which the facing unit presses the transfer material and enters the transfer body, a disturbance occurs in the toner image that is to be formed on or that has been formed on the transfer body, due to the impact of the entry.

Aspects of non-limiting embodiments of the present disclosure relate to an image forming apparatus that suppress a disturbance of a toner image that is to be formed on or that has been formed on a transfer body in a case where a facing unit that moves in a transport direction in which an object is transported is pressed against the transfer body.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: a transfer unit that comes into contact with an object to transfer an image to the object; a facing unit that moves together with the object in a transport direction of the object to bring the object into contact with the transfer unit; and a mechanism that brings the facing unit closer to the transfer unit in accordance with movement of the facing unit in the transport to bring the object into contact with the transfer unit and then further brings the facing unit and the transfer unit closer to each other.

### BRIEF DESCRIPTION OF THE DRAWINGS

Exemplary embodiment(s) of the present invention will be described in detail based on the following figures, wherein:

FIG. 1 is a diagram showing a configuration of an image forming apparatus to which a first exemplary embodiment is applied;

FIG. 2 is a diagram showing a transfer unit and a transport unit of an image forming unit;

FIG. 3 is a diagram showing the transport unit;

FIG. 4 is a diagram showing a fixing plate;

FIG. 5 is a diagram showing a fixing portion;

FIG. 6 is a diagram showing a load unit;

FIG. 7A is a diagram showing a state before the fixing portion comes into contact with a first surface, and FIG. 7B is a diagram showing a state in which an object is in contact with an intermediate transfer belt;

FIG. 8A is a diagram showing a state in which the object is located at a position immediately below a backup roll, and FIG. 8B is a diagram showing a state in which the object is located at a transfer position T;

FIG. 9 is a diagram showing the transport unit; and

FIG. 10 is a diagram showing a mechanism that moves a holding unit in an up-down direction.

### DETAILED DESCRIPTION

Hereinafter, exemplary embodiments of the present invention will be described in detail with reference to the accompanying drawings.

An image forming apparatus to which the present exemplary embodiment is applied is an image forming apparatus using an electrophotographic method. In a case of the electrophotographic method, a transfer unit and a medium come into contact with each other in a case where an image is transferred to the medium. In addition, in the present exemplary embodiment, a cylindrical metal can having a circumferential surface is assumed as an object to be printed.

### First Exemplary Embodiment

### Configuration of Image Forming Apparatus 1

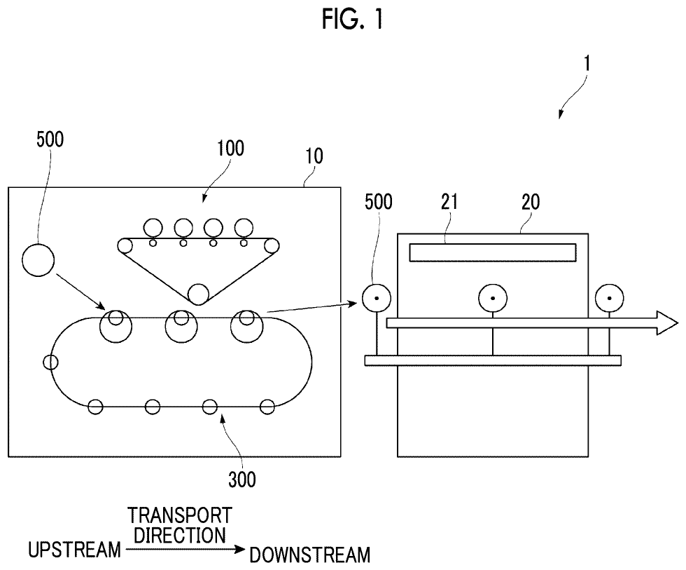

FIG. 1 is a diagram showing a configuration of an image forming apparatus to which a first exemplary embodiment is applied. The image forming apparatus 1 includes an image forming unit 10 and a fixing unit 20. In addition, although not particularly shown, the image forming apparatus 1 includes a control unit that controls the image forming apparatus 1. The control unit includes one or a plurality of processors as a operation unit and a memory as a work area in data processing. In addition, the control unit includes a storage device that holds a program or data. The control unit may be a single unit that controls an operation of the entire image forming apparatus 1, or may be provided in each of the image forming unit 10, the fixing unit 20, and the like.

The image forming unit 10 includes a transfer unit 100 and a transport unit 300. The transfer unit 100 is a unit that forms an image formed of particles such as toner, and comes into contact with an object 500 to transfer the image. The transport unit 300 transports the object 500 and brings the transfer unit 100 into contact with the object 500. The object 500 to which the image is transferred is detached from the transport unit 300 and transported to the fixing unit 20. In the image forming unit 10, a direction in which the object 500 moves will be referred to as a transport direction.

The fixing unit 20 is a unit that fixes the image transferred to the object 500 to a surface of the object 500 by heating the image. The fixing unit 20 includes a heat source 21 that generates heat during the heating. As the heat source 21, for example, various existing heat sources, such as a halogen lamp, a ceramic heater, and an infrared lamp, may be used. The fixing unit 20 discharges the object 500 on which the image is fixed, from the fixing unit 20.

In the first exemplary embodiment, a transport device for transporting the object 500 is provided in each of the image forming unit 10 and the fixing unit 20. However, the image forming unit 10 and the fixing unit 20 may be provided with a single transport device. For example, the transport unit 300 of the image forming unit 10 may be extended to the fixing unit 20. In this case, the object 500 is transported to the fixing unit 20 by the transport unit 300 and is heated at the fixing unit 20 without being detached from the transport unit 300.

### Configuration of Image Forming Unit 10

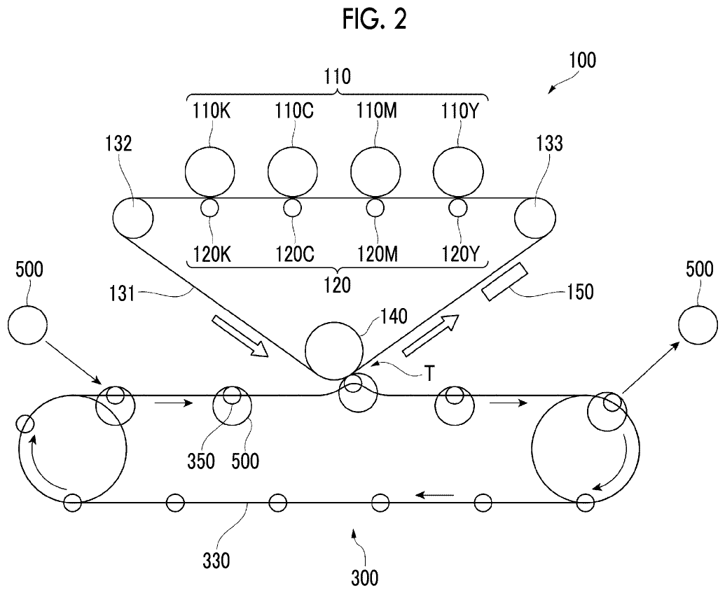

Subsequently, the image forming unit 10 will be described with reference to FIG. 2.

FIG. 2 is a diagram showing the transfer unit 100 and the transport unit 300 of the image forming unit 10.

The transfer unit 100 forms the image using charged particles and generates an electric field to transfer the image to a cylindrical surface of the object 500 having a cylindrical shape. The transfer unit 100 includes a developing device 110, a primary transfer roll 120, and an intermediate transfer belt 131. The intermediate transfer belt 131 is stretched between the developing device 110 and a position at which the intermediate transfer belt 131 is transferred to the object 500, by rollers 132 and 133 and a backup roll 140. In addition, the transfer unit 100 includes a cleaning device 150 for removing particles adhering to the intermediate transfer belt 131.

The developing device 110 is a unit that forms, on a photoreceptor, an electrostatic latent image of the image to be transferred and develops the image by causing the charged particles to adhere to the electrostatic latent image on the photoreceptor. As the developing device 110, the existing device used in the image forming apparatus using the electrophotographic method may be used. FIG. 2 shows a configuration example in a case where color image forming processing, using four colors including black in addition to three colors of yellow, magenta, and cyan, is performed. The developing device 110 is provided for each of these colors and, in FIG. 2, the developing devices 110 for the respective colors of yellow, magenta, cyan, and black are respectively shown with indexes “Y”, “M”, “C”, and “K” indicating the corresponding colors. In the following description, in a case where the respective colors are distinguished for the developing device 110, the description will be made using the reference numeral with the indexes Y, M, C, and K, but, in a case where there is no need to distinguish between the respective colors, the description will be made without using the indexes.

The primary transfer roll 120 is a unit used for primarily transferring the image formed in the developing device 110 to the intermediate transfer belt 131. The primary transfer roll 120 is disposed to face the photoreceptor of the developing device 110, and is configured such that the intermediate transfer belt 131 is located between the developing device 110 and the primary transfer roll 120. The primary transfer roll 120 is provided to correspond to each of the developing devices 110Y, 110M, 110C, and 110K. In FIG. 2, the primary transfer rolls 120 corresponding to the developing devices 110Y, 110M, 110C, and 110K of the respective colors are respectively shown with indexes “Y”, “M”, “C”, and “K” indicating the corresponding colors. In the following description, in a case where the respective colors are distinguished for the primary transfer rolls 120, the description will be made using the reference numeral with the indexes Y, M, C, and K, but, in a case where there is no need to distinguish between the respective colors, the description will be made without using the indexes.

The intermediate transfer belt 131, the rollers 132 and 133, and the backup roll 140 are units used to transfer the image formed in the developing devices 110 to the object 500. As shown in FIG. 2, the intermediate transfer belt 131 rotates in an arrow direction in FIG. 2 (counterclockwise direction in the shown example) in a state of being hung on and stretched over the rollers 132 and 133 and the backup roll 140. The rotation of the intermediate transfer belt 131 is performed, for example, by using one or both of the rollers 132 and 133 as rotationally driving rollers and pulling the intermediate transfer belt 131 via the rotation of the rollers.

In the configuration example of FIG. 2, an outer surface of the intermediate transfer belt 131 is a surface that holds the image. Hereinafter, the outer surface of the intermediate transfer belt 131 will be referred to as a transfer surface. In a case where the intermediate transfer belt 131 passes through a space between the developing device 110 and the primary transfer roll 120, the image is transferred from the photoreceptor of the developing device 110 to the transfer surface of the intermediate transfer belt 131. In the configuration example shown in FIG. 2, a multicolor image is formed by superimposing a yellow (Y) image, a magenta (M) image, a cyan (C) image, and a black (K) image on the transfer surface by the developing devices 110Y, 110M, 110C, and 110K and the primary transfer rolls 120Y, 120M, 120C, and 120K.

The backup roll 140 brings the transfer surface of the intermediate transfer belt 131 into contact with the object 500 to transfer (secondarily transfer) the image to the medium. A predetermined voltage is applied to the backup roll 140 in a case where the image is transferred. As a result, an electric field (hereinafter, referred to as a “transfer electric field”) is generated in a range including the backup roll 140 and the object 500. Then, the image formed by the charged particles is transferred from the intermediate transfer belt 131 to the object 500. As described above, in order to transfer the image from the intermediate transfer belt 131 to the object 500, it is necessary for a current to flow from the backup roll 140 to the object 500 via the intermediate transfer belt 131. Here, in a case where the object 500 is a conductor such as metal, the current flows through the object 500, so that the transfer electric field is generated to transfer the image to the surface of the object 500. On the other hand, in a case where the object 500 is not the conductor, the current does not flow through the medium, and thus the image cannot be transferred in such a state. Therefore, in a case where a material that is not the conductor is used as the object 500, it is necessary to allow the current to flow through the object 500 in advance in a region on the surface of the object 500 on which at least an image is to be formed. For example, the current is allowed to flow through the object 500 by means of forming a layer (hereinafter, referred to as a “conductive layer”) of a conductive material on the object 500, and the like.

A procedure of the image transfer performed by the intermediate transfer belt 131 will be described. In a case where the intermediate transfer belt 131 rotates, a yellow (Y) image, a magenta (M) image, a cyan (C) image, and a black (K) image are sequentially superimposed on the transfer surface (the outer surface in FIG. 2) of the intermediate transfer belt 131 by the developing devices 110Y, 110M, 110C, and 110K and the primary transfer rolls 120Y, 120M, 120C, and 120K, so that a multicolor image is formed. In a case where the intermediate transfer belt 131 further rotates, the image formed on the transfer surface of the intermediate transfer belt 131 moves. Then, the image formed on the intermediate transfer belt 131 reaches a position (hereinafter, referred to as a “transfer position T”) at which the image is transferred to the object 500. Therefore, as described above, the voltage is applied to the backup roll 140 to generate the transfer electric field, and the image is transferred from the intermediate transfer belt 131 to the object 500. Hereinafter, a direction in which the backup roll 140 extends may be referred to as a device direction. In FIG. 2, the backup roll 140 extends in a direction perpendicular to a paper surface. In FIG. 2, a back side of the paper surface will be referred to as a back side in the device direction, and a front side of the paper surface in FIG. 2 will be referred to as a front side in the device direction.

The cleaning device 150 is a unit that removes the particles adhering to the transfer surface of the intermediate transfer belt 131. The cleaning device 150 is provided, in a rotation direction of the intermediate transfer belt 131, on a downstream side of the transfer position and on an upstream side of the developing device 110Y and the primary transfer roll 120Y.

Accordingly, after the image is transferred from the intermediate transfer belt 131 to the object 500, the particles remaining on the transfer surface of the intermediate transfer belt 131 are removed by the cleaning device 150. Then, in the next operation cycle, an image is newly transferred (primarily transferred) to the transfer surface from which the particles have been removed.

### Transport Unit 300

The transport unit 300 includes a circulating unit 330 and a holding unit 350.

The circulating unit 330 constitutes a circulating transport path.

The holding unit 350 holds the object 500 having a cylindrical shape and brings the object 500 into contact with the transfer unit 100. The holding unit 350 is attached to the circulating unit 330 to circulate along the transport path. The holding unit 350 moves together with the object 500 in a part of the circulating transport path.

In a case of performing the secondary transfer, the holding unit 350 presses the object 500 in contact with the intermediate transfer belt 131 toward the backup roll 140 side. The holding unit 350 is an example of a facing unit facing the backup roll 140 in a case where the image is secondarily transferred to the object 500.

A plurality of holding units 350 are provided at predetermined intervals in the transport path of the circulating unit 330.

In a case where the secondary transfer is performed on the object 500, the circulating unit 330 is stopped from circulating and moving, and the object 500 is temporarily stopped at the transfer position T. At the transfer position T, the circumferential surface of the object 500 rotates in accordance with the intermediate transfer belt 131, and the image is transferred to the circumferential surface of the object 500. In addition, the object 500 is attached to and detached from the holding unit 350 in accordance with a timing at which the circulating and moving of the circulating unit 330 are stopped. More specifically, a new object 500 is supplied on the upstream side of the transfer position T in the transport direction and is attached to the holding unit 350. In addition, the object 500 to which the image is transferred is removed from the holding unit 350 on the downstream side of the transfer position T in the transport direction.

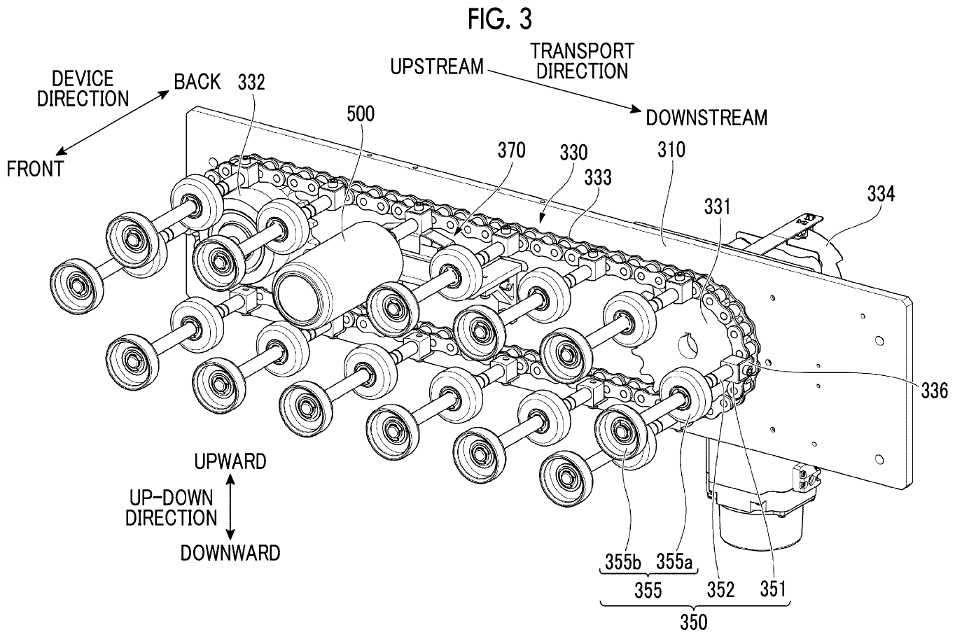

Subsequently, the transport unit 300 will be described in more detail with reference to FIG. 3.

FIG. 3 is a diagram showing the transport unit 300.

The device direction shown in FIG. 3 is a direction orthogonal to the transport direction, and is an axial direction of the backup roll 140 (see FIG. 2). In addition, FIG. 3 shows a state in which one object 500 is held by one of the holding units 350.

The transport unit 300 includes a frame 310 and a load unit 370, in addition to the circulating unit 330 and the holding unit 350.

The frame 310 is a base to which the configuration of the transport unit 300 is attached. The frame 310 is disposed below the transfer unit 100 (see FIG. 2). The frame 310 is a flat plate-shaped member, and is disposed such that a plate surface faces the device direction.

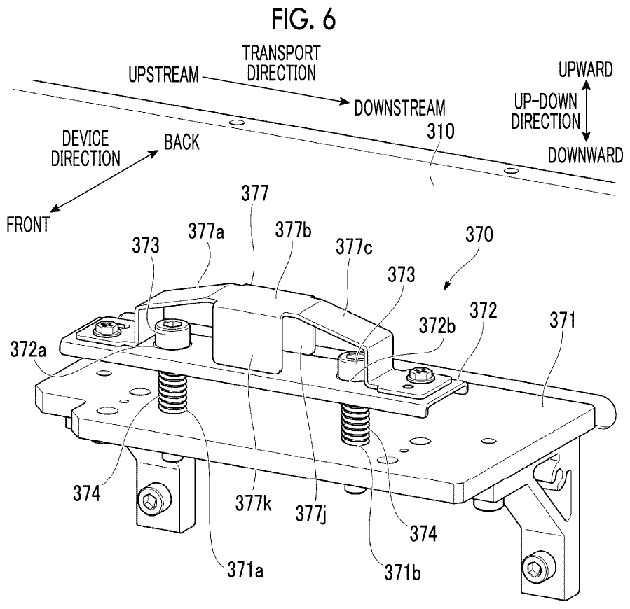

The load unit 370 moves the holding unit 350 in an up-down direction that is a direction intersecting the transport direction. The load unit 370 is disposed below the backup roll 140 (see FIG. 2). The load unit 370 will be described in detail with reference to FIG. 6.

### Circulating Unit 330

The circulating unit 330 includes a first sprocket 331, a second sprocket 332, and a chain 333. In addition, the circulating unit 330 includes a drive source 334 that drives the first sprocket 331.

The first sprocket 331 is attached to the frame 310 in a rotatable manner. The first sprocket 331 is provided on the downstream side in the transport direction in the frame 310.

The second sprocket 332 is attached to the frame 310 in a rotatable manner. The second sprocket 332 is provided on the upstream side in the transport direction in the frame 310.

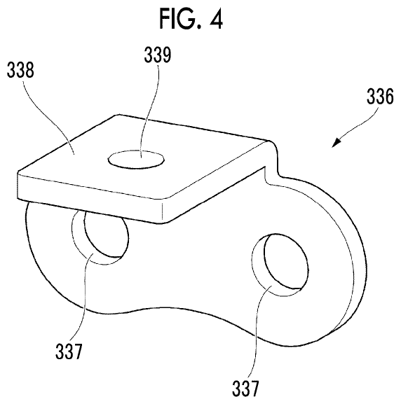

The chain 333 is wound around the first sprocket 331 and the second sprocket 332 to circulate. In the shown example, the chain 333 is a roller chain in which outer links and inner links are alternately combined and connected. A fixing plate 336 for fixing the holding unit 350 is provided on a part of a plate constituting the roller chain. A plurality of fixing plates 336 are provided at intervals at which the holding unit 350 is attached to the chain 333. The fixing plate 336 will be described in detail with reference to FIG. 4.

The drive source 334 is attached to a position facing the first sprocket 331 with the frame 310 interposed between the drive source 334 and the first sprocket 331. The drive source 334 is connected to a rotation shaft of the first sprocket 331 and rotates the first sprocket 331. The drive source 334 may be any drive source as long as the drive source can control the rotation of the first sprocket 331, and, for example, a stepping motor is used as an example of the drive source 334.

### Holding Unit 350

The holding unit 350 includes a fixing portion 351, a shaft 352, and a support portion 355.

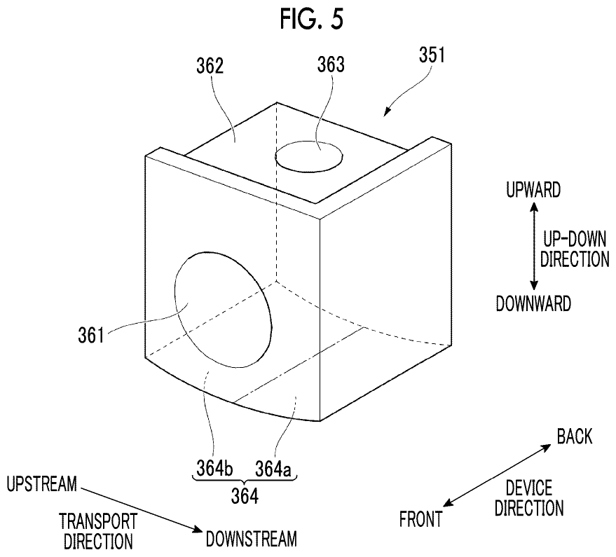

The fixing portion 351 is a member having a substantially cuboidal shape that fixes the holding unit 350 to the chain 333. The fixing portion 351 is fixed to the fixing plate 336. The fixing portion 351 comes into contact with the load unit 370 while moving in the transport direction. The fixing portion 351 comes into contact with the load unit 370 to bring the holding unit 350 and the transfer unit 100 closer to each other. The fixing portion 351 and the load unit 370 are an example of a mechanism that brings the holding unit 350 and the transfer unit 100 closer to each other. The fixing portion 351 will be described in detail with reference to FIG. 5.

The shaft 352 is a rod-like member. The shaft 352 is disposed to extend in the device direction. In addition, one end portion of the shaft 352 in a direction in which the shaft 352 extends is attached to the fixing portion 351. The shaft 352 has a through-hole perpendicular to the direction in which the shaft 352 extends on one end portion side attached to the fixing portion 351. The shaft 352 is attached to the fixing portion 351 with a bolt passing through the through-hole.

The support portion 355 supports the object 500 having the circumferential surface from an inner peripheral side of the circumferential surface. In a case of transferring the image to the object 500, the support portion 355 interposes the object 500 between the transfer unit 100 and the support portion 355.

The support portion 355 is attached to the shaft 352, and has a circumferential surface centered on the shaft 352. A radius of the circumferential surface is shorter than a radius of an inner side of the circumferential surface of the object 500 in order to support the inner side of the circumferential surface of the object 500.

In the first exemplary embodiment, the support portion 355 includes a back-side support portion 355a and a front-side support portion 355b. The back-side support portion 355a is fixed to the shaft 352, and is fixed to the shaft 352 on the back side in the device direction. The back-side support portion 355a has a disk shape, and includes a bearing at the center of the disk. A shaft 352 is fixed to an inner ring of the bearing, and the bearing is attached in a rotatable manner about the shaft 352.

The front-side support portion 355b has the same configuration as the back-side support portion 355a. The front-side support portion 355b is fixed to the shaft 352, and is fixed to the front side of the shaft 352 in the device direction. The front-side support portion 355b has a disk shape, and includes a bearing at the center of the disk. The shaft 352 is fixed to an inner ring of the bearing, and the bearing is attached in a rotatable manner about the shaft 352.

The back-side support portion 355a and the front-side support portion 355b are disposed at a predetermined interval in the direction in which the shaft 352 extends. This predetermined interval is determined, for example, depending on a region in which the image is transferred to the object 500. For example, the back-side support portion 355a and the front-side support portion 355b are disposed at an interval that allows supporting one end side and the other end side of the region in which the image is transferred in a direction in which a cylinder of the cylindrical object 500 extends. In other words, the support portion 355 supports the object 500 by coming into contact with one end side and the other end side of the circumferential surface of the object 500 in a direction intersecting a circumferential direction of the circumferential surface, the direction being along the circumferential surface. In addition, the support portion 355 may be, for example, a cylindrical member that comes into contact with the entire region of the circumferential surface of the object 500 to which the image is transferred.

Subsequently, a state in which the fixing portion 351 is fixed to the fixing plate 336 will be described in more detail with reference to FIGS. 4 and 5.

FIG. 4 is a diagram showing the fixing plate 336.

FIG. 5 is a diagram showing the fixing portion 351.

The fixing plate 336 shown in FIG. 4 includes two pin holes 337 and an attachment portion 338.

The pin holes 337 are through-holes through which a pin for connecting the links of the chain 333 passes (see FIG. 3). The attachment portion 338 is a plate-shaped portion for attaching the fixing portion 351 (see FIG. 5). The attachment portion 338 includes an attachment hole 339 that is a through-hole through which a bolt for attaching the fixing portion 351 passes.

The device direction shown in FIG. 5 indicates a direction of the fixing portion 351 in a case where the fixing portion 351 is attached to the fixing plate 336. In addition, the transport direction shown in FIG. 5 indicates a direction of the fixing portion 351 in a state in which the fixing portion 351 is transported toward the load unit 370 (see FIG. 3). Further, the up-down direction shown in FIG. 5 indicates a direction of the fixing portion 351 in a state in which the fixing portion 351 is transported toward the load unit 370.

The fixing portion 351 includes a shaft hole 361, a top portion 362, a bolt hole 363, and a bottom portion 364.

The shaft hole 361 is a through-hole provided in the fixing portion 351, and a direction in which the through-hole penetrates is along the device direction. The shaft hole 361 is provided in accordance with a shape of the shaft 352 in order to insert the shaft 352 (see FIG. 3).

The top portion 362 is an upper surface in the up-down direction. The top portion 362 comes into contact with the attachment portion 338 of the fixing plate 336 in a case where the fixing plate 336 and the fixing portion 351 are fixed. The top portion 362 is used for registration between the fixing portion 351 and the fixing plate 336.

The bolt hole 363 is a through-hole into which a bolt that connects and fastens the fixing plate 336, the fixing portion 351, and the shaft 352 is inserted. The shaft hole 361 and the bolt hole 363 intersect each other inside the fixing portion 351. A through-hole provided at an end portion of the shaft 352 inserted from the shaft hole 361 communicates with the bolt hole 363. The bolt is inserted in a state in which the through-hole of the shaft 352 and the bolt hole 363 communicate with each other, and the fixing plate 336 and the shaft 352 are fixed to the fixing portion 351.

The bottom portion 364 is a surface that is located on a side opposite to the top portion 362. The bottom portion 364 has an R-shape, and is an arc-shaped surface in which a circumferential direction of an arc is along the transport direction and that protrudes downward in the up-down direction. Among the surfaces of the bottom portion 364, a surface located on the downstream side in the transport direction will be referred to as a downstream surface 364a. In addition, among the surfaces of the bottom portion 364, a surface located on the upstream side in the transport direction will be referred to as an upstream surface 364b. A one-dot chain line shown in FIG. 5 is a line indicating a boundary between the downstream surface 364a and the upstream surface 364b. The downstream surface 364a is a surface that extends upward in the up-down direction toward the downstream side in the transport direction. The upstream surface 364b is a surface that extends downward in the up-down direction toward the downstream side in the transport direction.

### Configuration of Load Unit 370

Subsequently, the load unit 370 will be described in more detail with reference to FIG. 6.

FIG. 6 is a diagram showing the load unit 370.

The load unit 370 includes a lower plate 371, an upper plate 372, a bolt 373, and an elastic member 374. In addition, the load unit 370 includes an inclined surface 377 on an upper side of the upper plate 372.

The lower plate 371 is fixed to the frame 310, and serves as a base that supports the entire load unit 370. The lower plate 371 is a plate-shaped member, and is disposed such that a plate surface is substantially parallel to a horizontal direction. The lower plate 371 is fixed to the frame 310 via an L-shaped bracket. A screw hole 371a for fixing the bolt 373 and a screw hole 371b are formed in the lower plate 371. A female screw is formed on inner peripheral surfaces of the screw hole 371a and the screw hole 371b. The screw hole 371a and the screw hole 371b are provided along the transport direction.

The upper plate 372 is a plate-shaped member, and is disposed above the lower plate 371 via the elastic member 374. The upper plate 372 has a rectangular plate surface, and is disposed such that a longitudinal direction of the rectangle is along the transport direction. The upper plate 372 is provided with a through-hole 372a and a through-hole 372b through which the bolt 373 passes.

The bolt 373 connects the lower plate 371 and the upper plate 372. The bolt 373 includes a head portion of the bolt and a shaft portion of the bolt. The shaft portion of the bolt includes a smooth body portion and a screw portion in which a male screw is cut. The screw portion is provided at a distal end portion of the bolt 373 opposite to the head portion. The male screw of the screw portion is fixed to the female screw of the screw hole 371a or the screw hole 371b of the lower plate 371. The upper plate 372 is movable up and down along the body portion of the bolt 373 via the through-hole 372a and the through-hole 372b.

The elastic member 374 applies a force so that the lower plate 371 and the upper plate 372 are separated from each other. The elastic member 374 is disposed between the lower plate 371 and the upper plate 372. The elastic member 374 is compressed in a case where the lower plate 371 and the upper plate 372 come closer with each other. The elastic member 374 need only generate a repulsive force in a case of being compressed, and a type of the elastic member 374 is not particularly limited. The elastic member 374 is, for example, a spring such as a compression coil spring, a leaf spring, or a disc spring. Further, rubber or the like having elasticity may be used as the elastic member 374. In the shown example, the elastic member 374 is the compression coil spring. The elastic member 374 is disposed in a state of being wound around the body portion of the bolt 373.

The inclined surface 377 comes into contact with the holding unit 350 (see FIG. 3) to define a distance between the holding unit 350 and the transfer unit 100 in accordance with the movement of the holding unit 350. The inclined surface 377 is formed by bending a plate-shaped base material. The inclined surface 377 has a first surface 377a, a second surface 377b, and a third surface 377c. In addition, the inclined surface 377 includes a reinforcing portion 377j and a reinforcing portion 377k for maintaining a shape of the inclined surface 377.

The first surface 377a comes into contact with the fixing portion 351 before the transfer. The first surface 377a extends upward in the up-down direction from the upstream side toward the downstream side in the transport direction. In other words, the inclined surface 377 has the first surface 377a that extends closer to the backup roll 140 from the upstream side in the transport direction toward the backup roll 140 (see FIG. 2).

The second surface 377b comes into contact with the fixing portion 351 during the transfer. The second surface 377b is provided continuously with the first surface 377a, and is provided on the downstream side of the first surface 377a in the transport direction. The second surface 377b is disposed substantially parallel to a horizontal plane without a change in height between the upstream side and the downstream side in the transport direction.

The third surface 377c comes into contact with the fixing portion 351 after the transfer. The third surface 377c is provided continuously with the second surface 377b, and is provided on the downstream side of the second surface 377b in the transport direction. The third surface 377c extends downward in the up-down direction from the upstream side toward the downstream side in the transport direction. In other words, the third surface 377c extends to a side farther away from the backup roll 140 from the upstream side toward the downstream side in the transport direction. The third surface 377c is continuous with the second surface 377b, and extends farther away from the transfer position toward the downstream side in the transport direction from the transfer position T (see FIG. 2).

The reinforcing portion 377j extends downward in the up-down direction from the back side of the second surface 377b in the device direction. In the reinforcing portion 377j, a distal end extending from the second surface 377b is in contact with the upper plate 372.

The reinforcing portion 377k extends downward in the up-down direction from the back side of the second surface 377b in the device direction. The reinforcing portion 377k has a distal end extending from the second surface 377b in contact with the upper plate 372, as in the reinforcing portion 377j.

[Relationship between Inclined Surface 377 of Load Unit 370 and Fixing Portion 351]

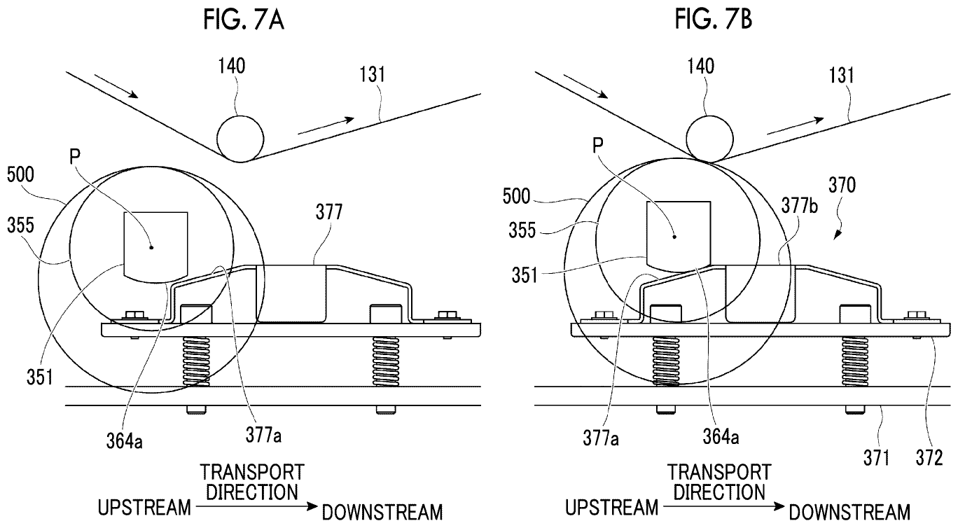

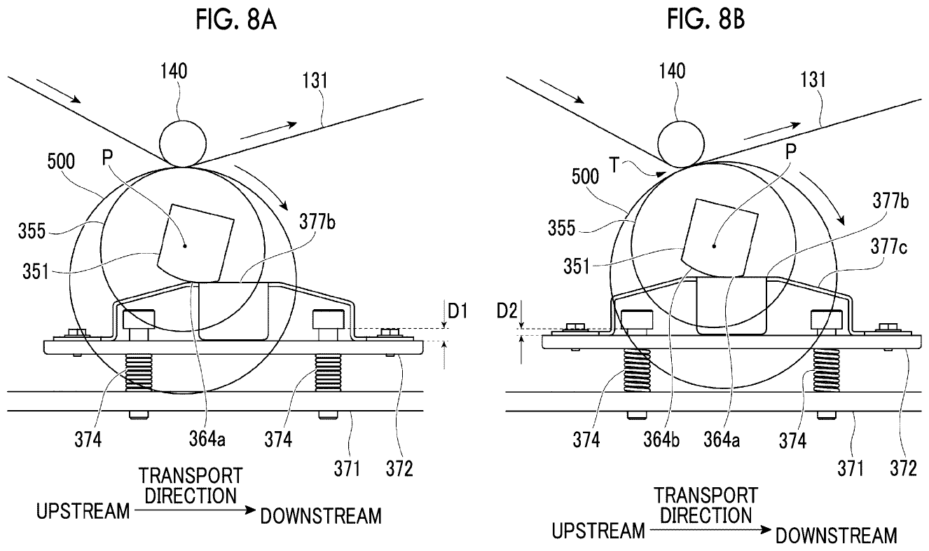

Subsequently, a relationship between the inclined surface 377 and the fixing portion 351 will be described with reference to FIGS. 7A and 7B and FIGS. 8A and 8B. FIGS. 7A and 7B and FIGS. 8A and 8B are schematic diagrams of the backup roll 140 as viewed from the front side to the back side in the device direction.

FIG. 7A is a diagram showing a state before the fixing portion 351 comes into contact with the first surface 377a. FIG. 7B is a diagram showing a state in which the object 500 is in contact with the intermediate transfer belt 131.

FIG. 8A is a diagram showing a state in which the object 500 is located at a position immediately below the backup roll 140. FIG. 8B is a diagram showing a state in which the object 500 is located at the transfer position T.

In order to form the image along the circumferential direction on the side surface of the object 500, which is the circumferential surface, it is necessary to move the side surface of the object 500 in accordance with the advancing of the intermediate transfer belt 131 in a state in which the object 500 is stopped at the transfer position T. Therefore, the support portion 355 holds the object 500 such that a central axis of the circumferential surface of the object 500 is orthogonal to the advancing direction of the intermediate transfer belt 131 at the transfer position, and rotates the object 500. The rotation direction of the object 500 is a direction in which the advancing of the circumferential surface matches the transfer direction of the intermediate transfer belt 131 at a position at which the intermediate transfer belt 131 and the circumferential surface of the object 500 are in contact with each other. In the examples shown in FIGS. 7A and 7B and FIGS. 8A and 8B, the object 500 is shown in a direction in which the central axis of the circumferential surface is perpendicular to the paper surface. Then, the intermediate transfer belt 131 advances from the left side to the right side in the drawing, and the object 500 rotates to the right side (clockwise) in the drawing.

The fixing portion 351 is moved in the transport direction by the chain 333 (see FIG. 3) being moved in the transport direction. A point P shown in FIG. 7A indicates a center point of an axis of the shaft 352 (see FIG. 3) fixed to the fixing portion 351. The support portion 355 has a circular outer shape centered on the point P. FIG. 7A shows the circumferential surface of the object 500 having a cylindrical shape. The support portion 355 supports the object 500 by coming into contact with the inside of the circumferential surface of the object 500. The support portion 355 is moved in the transport direction together with the object 500.

As shown in FIG. 7A, the first surface 377a and the downstream surface 364a face each other. In a case where the chain 333 moves in the transport direction, the downstream surface 364a of the fixing portion 351 approaches the first surface 377a in the same direction. Accordingly, the direction in which the downstream surface 364a faces is not changed before and after the downstream surface 364a and the first surface 377a come into contact with each other. Therefore, in a case where the downstream surface 364a and the first surface 377a come into contact with each other, the disturbance of the chain 333 is suppressed.

As shown in FIG. 7B, the fixing portion 351 is moved in the transport direction, and is moved upward along the first surface 377a. As a result, the outer peripheral side of the circumferential surface of the object 500 comes into contact with the intermediate transfer belt 131. In other words, the first surface 377a brings the object 500 farther away from the intermediate transfer belt 131 on the upstream side in the transport direction on the first surface 377a. In addition, the first surface 377a brings the object 500 into contact with the intermediate transfer belt 131 on the downstream side in the transport direction on the first surface 377a.

In a case where the object 500 comes into contact with the intermediate transfer belt 131, the intermediate transfer belt 131 is driven by advancing. The object 500 rotates about the central axis of the circumferential surface of the object 500. The object 500 in contact with the intermediate transfer belt 131 approaches the transfer position T while rotating and changing a position facing the backup roll 140 in front of the transfer position T in the advancing direction of the intermediate transfer belt 131. In other words, the load unit 370 further brings the holding unit 350 and the transfer unit 100 closer to each other after the object 500 comes into contact with the transfer unit 100.

As shown in FIG. 7B, on the first surface 377a, a distance between the backup roll 140 and the first surface 377a decreases toward in the transport direction. In addition, the backup roll 140 is fixed and is not moved even in a case where the object 500 is pressed. On the other hand, the first surface 377a can be moved downward by the upper plate 372 being sunk on the lower plate 371 side. Therefore, the fixing portion 351 presses the object 500 against the backup roll 140 side via the support portion 355 and advances in the transport direction while sinking the upper plate 372.

In a case where the fixing portion 351 advances in the transport direction along the first surface 377a, the fixing portion 351 moves along the second surface 377b continuously from the first surface 377a. As shown in FIG. 8A, the downstream surface 364a of the fixing portion 351 presses the second surface 377b downward to sink the upper plate 372 downward.

A length to which the upper plate 372 is sunk is shown as a length D1 in FIG. 8A. The elastic member 374 is compressed between the upper plate 372 and the lower plate 371. The elastic member 374 is compressed to apply an upward force to the upper plate 372. A pressure between the intermediate transfer belt 131 and the object 500, which are interposed between the backup roll 140 and the support portion 355, increases.

In a case where the fixing portion 351 advances in the transport direction along the second surface 377b, the object 500 is transported to the transfer position T shown in FIG. 8B. In a case where the object 500 is transported to the transfer position T, the second surface 377b presses the object 500 against the transfer unit 100 with a pressure required for the transfer after the object 500 comes into contact with the transfer unit 100 due to the movement of the holding unit 350. In a case where the object 500 is transported to the transfer position T, the rotational driving of the first sprocket 331 (see FIG. 3) is stopped. In a case where the rotational driving of the first sprocket 331 is stopped, the movement of the fixing portion 351 in the transport direction is stopped, and the object 500 stays at the transfer position T. In a state in which the object 500 stays at the transfer position T, the circumferential surface of the object 500 rotates to perform the transfer. Then, after the transfer of the image to the object 500 is completed, the first sprocket 331 is rotated to move the holding unit 350 in the transport direction. The holding unit 350 is brought farther away from the transfer unit 100 in accordance with the movement of the holding unit 350.

In addition, in a state in which the object 500 is transported to the transfer position T, the length to which the upper plate 372 is sunk is shown as a length D2 in FIG. 8B, and D1>D2. At the transfer position T, the elastic member 374 is in a compressed state, and a upward nip pressure is applied to press the object 500 against the intermediate transfer belt 131 of the transfer unit 100 with the pressure required for the transfer.

From FIG. 8B, in a case where the fixing portion 351 is further moved in the transport direction along the second surface 377b, the fixing portion 351 reaches the third surface 377c that is continuous with the second surface 377b. On the third surface 377c, the bottom portion 364 of the fixing portion 351 moves to the downstream side in the transport direction while coming into contact with the third surface 377c. As a result, the object 500 is gradually brought farther away from the transfer unit 100.

In the first exemplary embodiment, as shown in FIG. 7A, the object 500 is moved in the transport direction at a position lower than the transfer position, and the object 500 is moved upward in the up-down direction by the load unit 370 and moved to a height of the transfer position T shown in FIG. 8B. For example, in a case where the object 500 is transported at the height of the transfer position T before coming into contact with the intermediate transfer belt 131 without using the load unit 370, an impact is instantaneously applied in a case where the object 500 comes into contact with the backup roll 140. In the first exemplary embodiment, the object 500 is gradually brought closer to the transfer position T after being brought into contact with the intermediate transfer belt 131, so that the impact in a case of being brought into contact with the intermediate transfer belt 131 is suppressed.

In addition, in the first exemplary embodiment, as shown in FIG. 8B, in a case where the object 500 is present at the transfer position T, the elastic member 374 is compressed, and the force of pressing the object 500 against the transfer unit 100 increases. On the other hand, as shown in FIG. 7B, in a case where the object 500 starts to come into contact with the transfer unit 100, the elastic member 374 is not compressed as compared with the state of FIG. 8B, and the force of pressing the object 500 against the transfer unit 100 is weak. Therefore, the impact in a case where the object 500 starts to come into contact with the transfer unit 100 is suppressed.

In the first exemplary embodiment, the transfer position T is provided on a further downstream side from the position immediately below the backup roll 140, instead of the position immediately below the backup roll 140, but the position immediately below the backup roll 140 may be used as the transfer position. In a case where the transfer is to be performed over substantially the entire circumference of the cylindrical peripheral portion of the object 500, it is necessary to quickly bring the object 500 and the intermediate transfer belt 131 farther away from each other after the transfer is performed over substantially the entire circumference of the object 500. However, in a case where the transfer is performed on the object 500 at the position immediately below the backup roll 140, the pressure from the load unit 370 makes it difficult to bring the object 500 farther away from the intermediate transfer belt 131 after the transfer is completed. Therefore, there is a possibility that the intermediate transfer belt 131 touches a transferred region again in the region of the circumferential surface of the object 500. In this case, a disturbance may occur in a transferred image. In a case where the transfer is performed at the position on the further downstream from the position immediately below the backup roll 140, the object 500 can be brought farther away from the intermediate transfer belt 131 more quickly than in a case where the transfer is performed at the position immediately below the backup roll 140, and the disturbance in the transferred image is suppressed.

### Second Exemplary Embodiment

In a second exemplary embodiment, a transport unit 400 having a different configuration from the transport unit 300 of the first exemplary embodiment is used. The same functions as the functions in the first exemplary embodiment will be denoted by the same reference numerals, and will not be described hereinbelow.

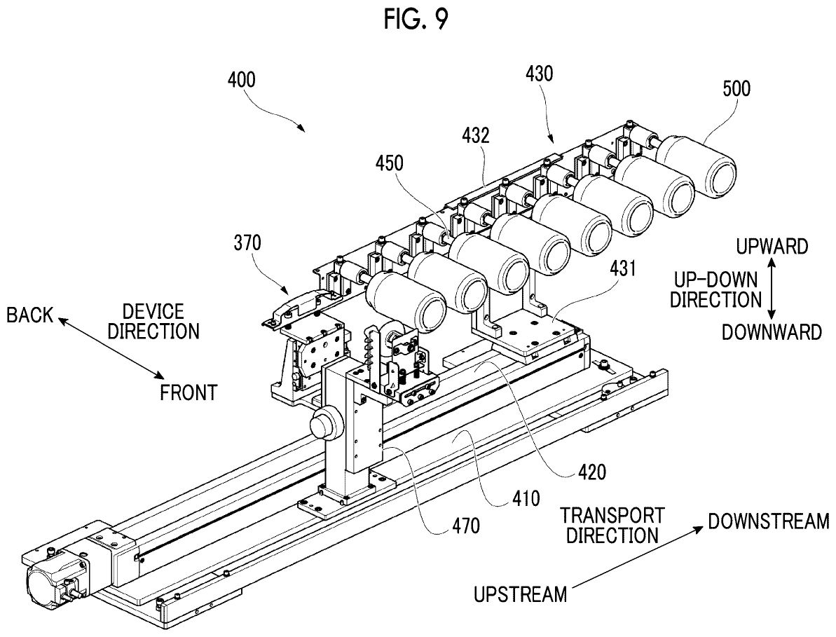

FIG. 9 is a diagram showing the transport unit 400, and shows a state of the transport unit 400 after the transfer is performed on the object 500. The transport unit 400 includes a frame 410, a transport rail 420, and a moving body 430. In addition, the transport unit 400 includes a holding unit 450 that holds the object 500, and the load unit 370.

The frame 410 serves as a base that supports the transport unit 400 from below in the up-down direction. The frame 410 extends in the transport direction.

The transport rail 420 is disposed along the transport direction to define a path along which the moving body 430 moves.

The moving body 430 moves along the transport rail 420. The moving body 430 repeats move from the upstream side to the downstream side of the load unit 370 in the transport direction and moving from the downstream side to the upstream side of the load unit 370. The moving body 430 is an example of a circulating unit.

The moving body 430 includes a leg portion 431 and a body portion 432.

The leg portion 431 is attached to be movable along the transport rail 420. A mechanism for moving the leg portion 431 on the transport rail 420 is not particularly limited. For example, the leg portion 431 may be provided with a drive device to be self-propelled, or means for pulling the leg portion 431 may be provided in the transport rail 420.

The body portion 432 is a member extending in the longitudinal direction, and is disposed substantially parallel to the transport direction. A plurality of holding units 450 are attached at predetermined intervals in the longitudinal direction. In the second exemplary embodiment, eight holding units 450 are attached to the body portion 432.

The holding unit 450 holds the object 500. The object 500 is attached to the holding unit 450 in a state in which the entire moving body 430 is located on the upstream side in the transport direction, and the number of objects 500 on which the printing is to be performed is attached. In addition, the object 500 is detached from the holding unit 450 in a state in which the entire moving body 430 is located on the downstream side in the transport direction, and the object 500 to which the image has been transferred is detached.

The load unit 370 is provided below the transfer position T (see FIG. 2) and is brought closer to the transfer position T by coming into contact with the holding unit 450. The load unit 370 is disposed on an upper portion of a support column 470 extending upward from the frame 410.

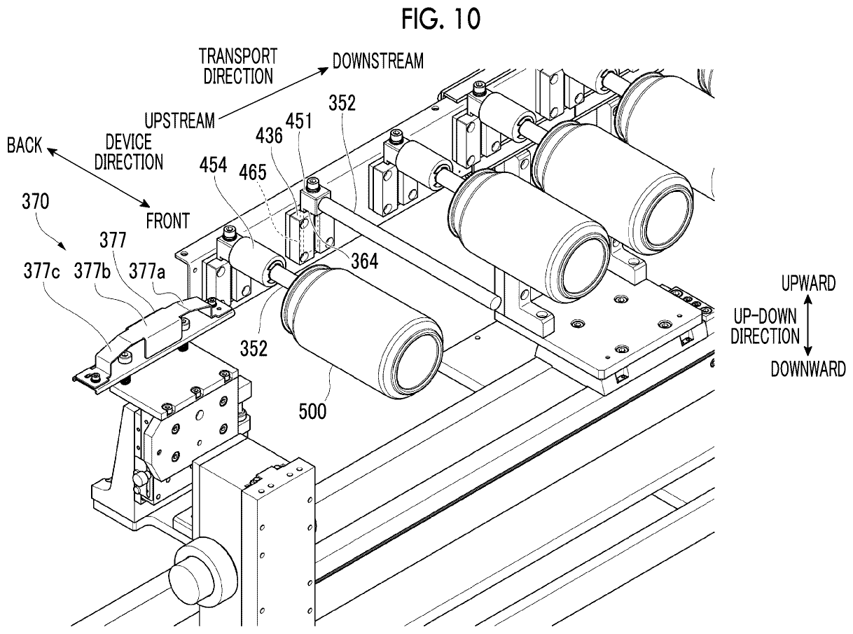

Subsequently, a mechanism in which the holding unit 450 (see FIG. 9) moves in the up-down direction will be described with reference to FIG. 10.

FIG. 10 is a diagram showing the mechanism in which the holding unit 450 moves in the up-down direction. In FIG. 10, a part of the holding unit 450 is removed in order to describe a fixing portion 451 and an outer slider 436.

The body portion 432 includes the outer slider 436. A plurality of outer sliders 436 are provided on the body portion 432 at predetermined intervals. In the second exemplary embodiment, eight outer sliders 436 are provided. The outer slider 436 holds the holding unit 450 in a movable manner in the up-down direction. The outer slider 436 includes a gap for an inner slider 465, which will be described later, to move in the up-down direction. The gap extends from an upper side to a lower side of the outer slider 436 along the up-down direction.

The holding unit 450 includes the fixing portion 451 in addition to the shaft 352 and the support portion 355 of the holding unit 350. Further, the holding unit 450 includes a contact portion 454.

The fixing portion 451 moves up and down along the gap of the outer slider 436. The fixing portion 451 includes the inner slider 465 that is inserted into the gap of the outer slider 436, in addition to the configuration of the fixing portion 351. The inner slider 465 extends downward in the up-down direction from the bottom portion 364 of the fixing portion 451. The fixing portion 451 in which the inner slider 465 is inserted into the gap of the outer slider 436 is stationary in a state in which the bottom portion 364 of the fixing portion 451 is in contact with an upper surface of the outer slider 436.

The contact portion 454 is provided on the shaft 352, and is provided on the front side of the fixing portion 451 in the device direction. The contact portion 454 is disposed at a position at least partially overlapping the inclined surface 377 of the load unit 370 in the device direction. The contact portion 454 is a cylindrical member, and is formed of, for example, a resin material having good sliding properties.

Here, a transfer operation according to the second exemplary embodiment will be described with reference to FIGS. 9 and 10.

In a case where the transfer is performed on the object 500, first, the object 500 is attached to the holding unit 450 on the upstream side in the transport direction. Then, the moving body 430 is transported to the downstream side along the transport rail 420. The moving body 430 is transported to the downstream side, and the contact portion 454 of the holding unit 450 on the most downstream side in the body portion 432 comes into contact with the inclined surface 377 of the load unit 370. The contact portion 454 is moved upward along the first surface 377a while advancing in the transport direction. In a case where the contact portion 454 is moved upward, the entire holding unit 450 is moved upward. In this case, the inner slider 465 moves upward in the gap of the outer slider 436.

Then, the contact portion 454 moves upward along the first surface 377a while advancing in the transport direction, and as a result, the object 500 comes into contact with the intermediate transfer belt 131 (see FIG. 7B). In a case where the contact portion 454 further advances in the transport direction, the contact portion 454 moves along the second surface 377b, and the object 500 is transported to the transfer position T (see FIG. 8B). In a case where the object 500 is transported to the transfer position T, the movement of the moving body 430 is stopped. Then, the object 500 stays at the transfer position T, the circumferential surface of the object 500 rotates while coming into contact with the image formed on the intermediate transfer belt 131, and the image is transferred.

In a case where the transfer to the object 500 is completed, the movement of the moving body 430 is restarted, and the contact portion 454 advances in the transport direction. The contact portion 454 moves downward along the third surface 377c while advancing in the transport direction. In a case where the bottom portion 364 of the fixing portion 351 comes into contact with the upper side of the outer slider 436, the contact portion 454 cannot no longer move downward from the bottom portion 364. The contact portion 454 that cannot no longer move downward cannot move along the third surface 377c and moves farther away from the third surface 377c while advancing in the transport direction.

In this way, in a case where the transfer of the object 500 held by the holding unit 450 located on the most downstream side in the body portion 432 is completed, the holding unit 450 located on the next downstream side in the body portion 432 comes into contact with the load unit 370, and the transfer of the object 500 is performed. This transfer operation is repeated to continuously perform the transfer on the object 500 attached to the holding unit 450 of the moving body 430. In a case where the entire moving body 430 moves to the downstream side of the load unit 370 in the transport direction, the object 500 attached to the holding unit 450 is detached. The moving body 430 from which the object 500 has been detached moves to the upstream side of the load unit 370 in the transport direction, to be in a standby state.

Although the first exemplary embodiment and the second exemplary embodiment have been described above, the technical scope of the present invention is not limited to the above-described exemplary embodiments. For example, in the above-described exemplary embodiments, the image forming apparatus using the electrophotographic method has been described. However, for example, the exemplary embodiment may be applied to an image forming apparatus that forms an image on an intermediate transfer belt by an ink jet method to transfer the image to the object. Additionally, various modifications or alternative configurations are included in the present invention without departing from the technical idea of the present invention.

### Supplementary Note

(((1)))

An image forming apparatus comprising:
a transfer unit that comes into contact with an object to transfer an image to the object;
a facing unit that moves together with the object in a transport direction of the object to bring the object into contact with the transfer unit; and
a mechanism that brings the facing unit closer to the transfer unit in accordance with movement of the facing unit in the transport to bring the object into contact with the transfer unit and then further brings the facing unit and the transfer unit closer to each other.
   (((2)))

The image forming apparatus according to (((1))),
wherein the mechanism brings the facing unit closer to the transfer unit from an upstream side of a transfer position, at which the transfer unit performs transfer on the object, in the transport direction in accordance with the movement of the facing unit to bring the object into contact with the transfer unit.
   (((3)))

The image forming apparatus according to (((2))),
wherein the mechanism brings the object into contact with the transfer unit in front of the transfer position and then further brings the facing unit and the transfer unit closer to each other in accordance with the movement of the facing unit, to press the object against the transfer unit at the transfer position with a pressure required for the transfer.
   (((4)))

The image forming apparatus according to (((3))),
wherein the mechanism brings the facing unit farther away from the transfer unit in accordance with the movement of the facing unit after the transfer of the image to the object is completed.
   (((5)))

The image forming apparatus according to (((1))),
wherein the mechanism has an inclined surface that comes into contact with the facing unit to define a distance between the facing unit and the transfer unit in accordance with the movement of the facing unit.
   (((6)))

The image forming apparatus according to (((5))),
wherein the inclined surface has a first surface that extends closer to the transfer unit from an upstream side in the transport direction toward the transfer unit.
   (((7)))

The image forming apparatus according to (((6))),
wherein the first surface brings the object farther away from the transfer unit on the upstream side in the transport direction and brings the object into contact with the transfer unit on a downstream side in the transport direction.
   (((8)))

The image forming apparatus according to (((6))),
wherein the inclined surface has a second surface that is continuous with the first surface and is used to press the object against the transfer unit with a pressure required for the transfer after the object comes into contact with the transfer unit due to the movement of the facing unit.
   (((9)))

The image forming apparatus according to (((8))),
wherein the inclined surface has a third surface that is continuous with the second surface and extends farther away from the transfer unit toward a downstream side in the transport direction from the transfer unit.
   (((10)))

The image forming apparatus according to any one of (((1))) to (((9))),
wherein the facing unit supports the object having a circumferential surface from an inner peripheral side of the circumferential surface, and the image is transferred to the circumferential surface of the object with the object interposed between the transfer unit and the facing unit.
   (((11)))

The image forming apparatus according to (((10))),
wherein the facing unit supports the object by coming into contact with one end side and the other end side of the circumferential surface of the object in a direction intersecting a circumferential direction of the circumferential surface, the direction being along the circumferential surface.
   (((12)))

The image forming apparatus according to any one of (((1))) to (((11))), further comprising:
a circulating unit that circulates along the transport direction,
wherein the facing unit is attached to the circulating unit to circulate.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a transfer unit that comes into contact with an object to transfer an image to the object;
a facing unit that moves together with the object in a transport direction of the object to bring the object into contact with the transfer unit; and
a mechanism that brings the facing unit closer to the transfer unit in accordance with movement of the facing unit in the transport to bring the object into contact with the transfer unit and then further brings the facing unit and the transfer unit closer to each other.

2. The image forming apparatus according to claim 1,
wherein the mechanism brings the facing unit closer to the transfer unit from an upstream side of a transfer position, at which the transfer unit performs transfer on the object, in the transport direction in accordance with the movement of the facing unit to bring the object into contact with the transfer unit.

3. The image forming apparatus according to claim 2,
wherein the mechanism brings the object into contact with the transfer unit in front of the transfer position and then further brings the facing unit and the transfer unit closer to each other in accordance with the movement of the facing unit, to press the object against the transfer unit at the transfer position with a pressure required for the transfer.

4. The image forming apparatus according to claim 3,
wherein the mechanism brings the facing unit farther away from the transfer unit in accordance with the movement of the facing unit after the transfer of the image to the object is completed.

5. The image forming apparatus according to claim 1,
wherein the mechanism has an inclined surface that comes into contact with the facing unit to define a distance between the facing unit and the transfer unit in accordance with the movement of the facing unit.

6. The image forming apparatus according to claim 5,
wherein the inclined surface has a first surface that extends closer to the transfer unit from an upstream side in the transport direction toward the transfer unit.

7. The image forming apparatus according to claim 6,
wherein the first surface brings the object farther away from the transfer unit on the upstream side in the transport direction and brings the object into contact with the transfer unit on a downstream side in the transport direction.

8. The image forming apparatus according to claim 6,
wherein the inclined surface has a second surface that is continuous with the first surface and is used to press the object against the transfer unit with a pressure required for the transfer after the object comes into contact with the transfer unit due to the movement of the facing unit.

9. The image forming apparatus according to claim 8,
wherein the inclined surface has a third surface that is continuous with the second surface and extends farther away from the transfer unit toward a downstream side in the transport direction from the transfer unit.

10. The image forming apparatus according to claim 1,
wherein the facing unit supports the object having a circumferential surface from an inner peripheral side of the circumferential surface, and
the image is transferred to the circumferential surface of the object with the object interposed between the transfer unit and the facing unit.

11. The image forming apparatus according to claim 10,
wherein the facing unit supports the object by coming into contact with one end side and the other end side of the circumferential surface of the object in a direction intersecting a circumferential direction of the circumferential surface, the direction being along the circumferential surface.

12. The image forming apparatus according to claim 10, further comprising:
a circulating unit that circulates along the transport direction,
wherein the facing unit is attached to the circulating unit to circulate.
